(19) United States
(12) Patent Application Publication
(10) Pub. No.: US 2006/0243747 A1
(43) Pub. Date: Nov. 2, 2006

(54) Hose pump feeding device

(76) Inventor: Hakan Dackefjord, Stockholm (SE)

Correspondence Address: Ralph A. Dowell of DOWELL & DOWELL P.C., 2111 Eisenhower Ave, Suite 406, Alexandria, VA, 22314, US

(21) Appl. No.: 10/545,706

(22) PCT Filed: Feb. 17, 2004
(86) PCT No.: PCT/SE04/00208

§ 371 Date: Jun. 15, 2006

(30) Foreign Application Priority Data
Feb. 20, 2003 (SE) 0300459-5

(51) Int. Cl. B67D 5/52

(52) U.S. Cl. 222/254

(57) ABSTRACT

A feeding device for materials that are difficult to feed, comprising an inlet (1), a hose pump (2) comprising a pump hose (11) which partly surrounds the circumference (13) of a pump wheel (12), which is provided with at least one pump cam (14), a feeding hose (4) arranged after the hose pump (2) and at least a first nozzle (3) arranged at the outlet of the hose pump (2) for supply of pressurized gas.

The present invention relates to a feeding device for materials that are difficult to feed, such as moist materials based on cement and plaster. These materials have a consistency similar to moist earth, such as concrete, mortar or grout. Above all it is difficult to feed not hardened lightweight concrete, meaning all cement mixtures with a density reduction, which density reduction can be achieved in different ways, such as by admixture of polymer particles or haydite or whipping-in air (so called foam concrete) or different combinations thereof.

### TECHNICAL BACKGROUND

At construction sites, for example, materials such as unhardened lightweight concrete comprising polymer particles or unhardened foam concrete which is “whipped” so that the material contains much air, have to be fed from e.g. transport containers or concrete trucks up into the building which is in the process of being built. The lightweight concrete or the foam concrete are often used as filler in floors and considerable amounts have to be fed up into the building each day. Occasionally, the material has to be fed up to high altitudes.

This is accomplished by pumping the material with a piston pump or screw pump, which can be electric, hydraulic or pneumatic, through a feeding hose up to a specific floor level and in to a specified pouring place, such as a floor.

The problem with pumping e.g. unhardened lightweight concrete with polymer particles as ballast or unhardened foam concrete is that the material is compressed at high pressure, e.g. arising when feeding the material over long distances or up to high altitudes.

When the compressed lightweight concrete then dries and sets, the polymer particles expand again and undesired stresses arise in the material. The air in the unhardened foam concrete is pressed out at high pressure, whereby the density of the material is increased and different material characteristics iare obtained for different floor levels. Further, the higher the pressure is during pumping, e.g. depending on how far or how high up in the building the material is to be pumped, the more larger volumes will be demanded. Accordingly, it will be difficult to estimate the consumption of material.

Examples of problems arising during post expansion of the material when drying is that the applied putty will crack or that the surface no longer is even but instead shows small dents and bosses, resulting in that the level of the floor must be raised which demands more putty. Another problem is that the isolation characteristics are deteriorated when the material is compressed.

In order to counteract the compression, more water and/or flowage agent have to be used in the lightweight or foam concrete, whereby the concrete will be more easy to feed and resists the compressing better. The problem with using more water and/or flowage agent in the concrete is that the concrete will dry more slow and the risk for drying cracks increases. The risk for damages due to moisture and mildew also increases.

### SUMMARY OF THE INVENTION

The object of the present invention is to provide a device capable of feeding difficult to feed materials.

The feeding device according to claim 1 solves the problems accompanying to the known technique because the hose pump out the material batchwise with the aid of the pump cam, which “divides” the material in the pump hose arranged around the pump wheel and pushes the batch of material forward until the pump wheel has rotated one turn and the pump cam again divides new material and pushes this next batch in front of it.

Preferably more than one pump cam are arranged on the pump wheel in order to provide desired batch volumes. The batch volume can of course also be controlled by the cross section area of the pump hose and the circumference of the pump wheel.

Pressurized gas, which is blown in through at least a first nozzle sends away the batch of material and provide for the formation of a gas pad is formed between each batch of material. In that why the batches of material are not compressed, but instead the gas pads between the batches of material are compressed. Thereby the material can be pumped to even higher altitudes without being affected.

According to one embodiment one or several further nozzles can be arranged along the feeding hose in the feeding direction of the material so that the batches of material receive further pushing action from pressurized gas, whereby feeding over e.g. longer distances and to higher altitudes can be obtained.

Thus the unhardened lightweight or foam concrete need not be diluted with extra water or a flowage agent, whereby the above mentioned drawbacks are eliminated.

Many materials which are difficult to feed often form bridges of material which clog when feeding out of a container or a feeding depot. According to a preferred embodiment of the present. invention an agitator is arranged in front of the hose pump.

### SHORT DESCRIPTION OF THE DRAWING

The present invention will now be described for illustrative purposes with reference to the accompanying drawing, on which:

FIG. 1 illustrates a preferred embodiment of the feeding device according to the invention.

### DETAILED DESCRIPTION OF A PREFERRED EMBODIMENT

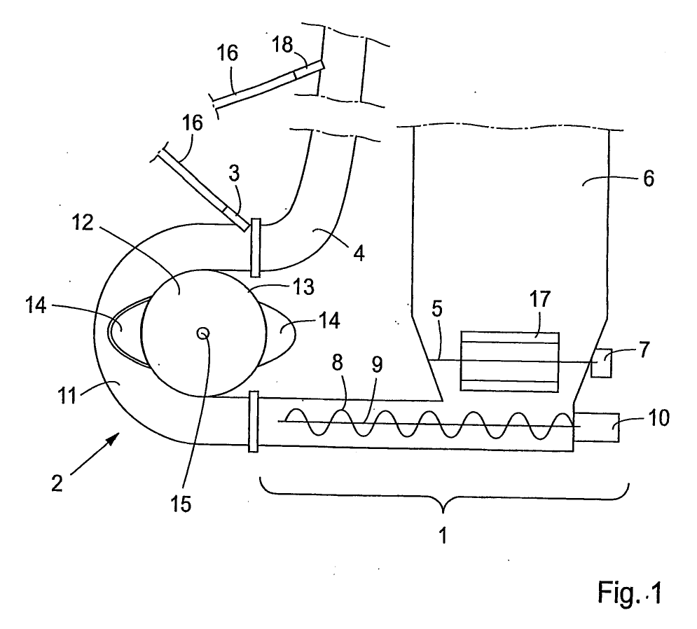

In FIG. 1 a preferred embodiment of the feeding device according to the present invention is illustrated. The feeding device comprises an inlet 1, a hose pump 2, a first nozzle 3 and a feeding hose 4, arranged in this order in the feeding direction.

Preferably the inlet 1 comprises an agitator 17 arranged around a axis of rotation 5. The agitator 5 can be a conventional agitator, the object of which is to prevent the formation of bridges of the material to be fed when feeding out from e.g. a container or a feeding depot 6. The agitator 17 is rotated around its axis of rotation 5 by means of a motor 7.

Preferably, the inlet 1 also comprises a feeding screw 8 arranged after the agitator 17 and before the hose pump 2, whose feeding screw 8 transports the material from the outlet of the storage container 6 to the hose pump 2. The transport screw 8 rotates around an axis of rotation 9 and is powered by a motor 10.

The hose pump 2 comprises a pump hose 11, which preferably has soft or elastic walls. The pump hose 11 abuts a pump wheel 12 along part of the circumference 13 of the pump wheel 12, preferably along at least half of the circumference 13. The pump wheel 12 is provided with at least one pump cam 14, in the illustrated case two cams.

The pump wheel 12 is rotated around its axis of rotation 15 by a motor (not shown), in a clockwise direction in FIG. 1. The material is transported into the pump hose 11 of the hose pump 2. When a pump cam 14 from its free position is coming in against the pump hose 11, the pump cam 14 drives the pump hose 11 together and flattens it so that at least an partial division of the material inside the pump hose 11 takes place.

When the pump wheel 12 rotates further the pump cam 14 pushes the material in front of it while the transport screw 8 transports more material into the pump hose 11. The other pump cam 14 will then drive the pump hose 11 together once again, whereupon a new batch of material is pushed forward through the pump hose 11 by the second pump cam 14. In that way the material will leave the hose pump 2 batchwise and be fed into the feeding hose 4.

Somewhere in the vicinity of the outlet from the hose pump 2 and the beginning of the feeding hose 4 sits the only or the first nozzle 3 in such a way that pressurized gas through a conduit 16 can be let into the material feeding channel close to the transition between the hose pump 2 and the feeding hose 4.

The pressurized gas which is blown in through the nozzle 3 sends the batch of material through the feeding hose 4 and causes the formation of a gas pad between each batch of material. The pressurized gas is preferably blown in continuously through the nozzle 3 but another possible solution is that it is only blown in between the batches of material. Such a solution however demands some kind of common control of the hose pump and the pressurized gas.

According to one embodiment, one or several further nozzles 18 are arranged along the feeding hose 4 in the feeding direction of the material in desired, mutual distances so that the batches of material gets further pushing action from the pressurized gas. The pressurized gas is supplied through conduits 16.

The invention is not limited to the above description and the accompanying drawing, but is only limited by the scope of claims.

1. A feeding device for materials that are difficult to feed, characterized by an inlet (1), a hose pump (2) comprising a pump hose (11), which partly surrounds the circumference (13) of a pump wheel (12), which is provided with at least one pump cam (14), a feeding hose (4) arranged downstream of the hose pump (2) and at least a first nozzle (3) arranged at the outlet of the hose pump (2) for supply of pressurized gas.

2. A feeding device according to claim 1, in which the material is fed out batchwise from the feeding device.

3. A feeding device according to claim 1, in which the inlet (1) comprises an agitator (17) for preventing formation of bridges in the material to be fed.

4. A feeding device according to claim 3, in which the inlet (1) comprises a transport screw (8) arranged between the agitator (17) and the hose pump (2) for feeding of the material into the hose pump (2).

5. A feeding device according to claim 1, in which at least one further nozzle (18) is arranged at the feeding hose (4) downstream of the first nozzle (3) seen in the feeding direction for the material.
